(19) United States
(12) Patent Application Publication
(10) Pub. No.: US 2007/0068766 A1
(43) Pub. Date: Mar. 29, 2007

(54) Electronic Coin Wallet

(76) Inventor: Giridhar Sithamraju, Irvine, CA (US)

Correspondence Address: Giridhar Sithamraju, 10 Cambridge, IRVINE, CA, 92620, US

(21) Appl. No.: 11/160,748

(22) Filed: Jul. 7, 2005

(51) Int. Cl. G07F 9/08; G06M 1/00; G06M 3/00

(52) U.S. Cl. 194/215

(57) ABSTRACT

Electronic Coin Wallet is to store the change in coin due to patrons to a shopping place in an electronic form at the shopping place and to be used for future purchases or optionally cash out the coins by emptying the electronic coin wallet.

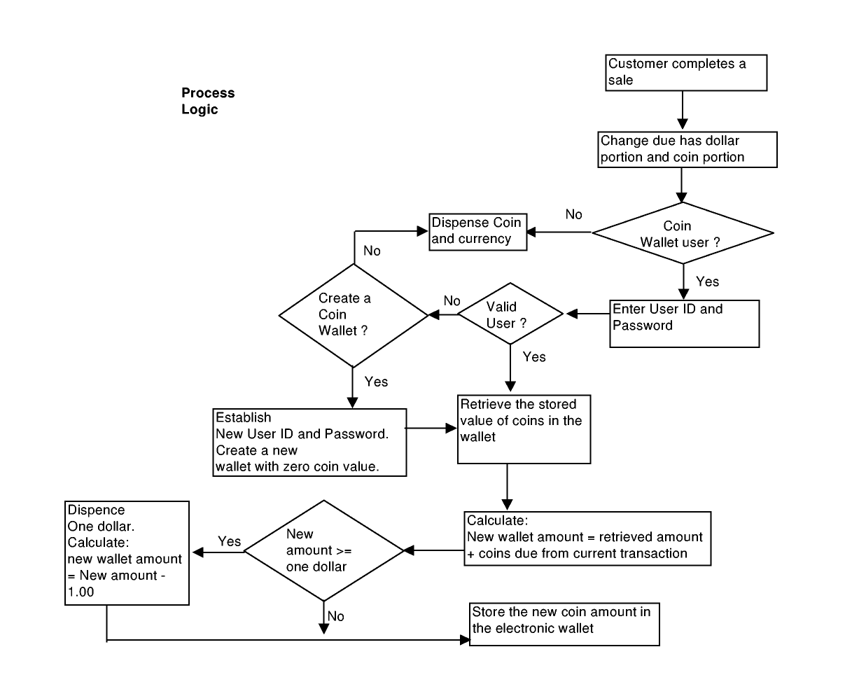

This is an electronic form of storing the change in coins that is due to a patron at a retail establishment like grocery stores, Kmart, Walmart and other chain shopping centers.

This system will interface with the POS system and COIN dispensing units. Each user will be issued a user identification number (user id) and password. Users will enter the user id and password using an electronic keypad. System will retrieve the store coin amount from previous purchase at the stores, the new change due is added to the retrieved amount. If the new amount is over a dollar, then a dollar will be given to the patron, and the new change in coins due will be stored with the user id and password in the system.

What is claimed is:

1. The method of storing electronic coin wallets at the store and the patrons will not have to carry any coin since amount less than a dollar will be stored in the database with patrons user id and password.
